(19) United States
(12) Patent Application Publication
(10) Pub. No.: US 2007/0263381 A1
(43) Pub. Date: Nov. 15, 2007

(54) Interchangeable self-contained lighting module

(76) Inventors: Robert I. Goldman, San Diego, CA (US); John D. Buchaca, La Mesa, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/374,304

(22) Filed: May 9, 2006

(51) Int. Cl. F21L 4/08

(52) U.S. Cl. 362/183

(57) ABSTRACT

A self contained and self powered interchangeable light emitting module for use in outdoor landscaping fixtures such as pathway lights and decorative garden brickwork. The module uses battery powered LED's which are switched off and the batteries recharged by a solar cell when the module is adequately illuminated. Both the LEDs and solar cell use a single translucent panel. The module uses a hermetic enclosures and contains a desiccant and anti-algae agent to discourage fouling from condensation. Differently colored modules are provided to conveniently allow seasonal lighting decoration choices. A single color changeable and microprocessor controlled module is provided for greater convenience and coloring options.

### FIELD OF THE INVENTION

This invention relates to lighting fixtures used in outdoor decorative structures, and more particularly to self-powered fixtures.

### BACKGROUND

In the landscaping arts, it is customary to provide various functional and aesthetic fixture types such as brickworks, walls, mailboxes, planters, and outdoor light housings. Often times such fixtures have been used to delineate or partially illuminate pathways, sidewalks, lawns and flower beds. Goldman, U.S. Pat. No. 5,317,833 discloses an imitation brick made from molded plastic which can be conveniently used to form edging strips for lawns, pathways and flower beds. It can be difficult to provide nighttime illumination to many of these fixtures in a convenient and aesthetically pleasing manner given the confines of many residential yards. Running hidden power lines to lighting devices can be difficult and costly.

Self-powered outdoor illumination systems have been proposed such as in Kuelbs, U.S. Pat. No. 7,021,787 utilizing batteries recharged by a solar power panel to illuminate a number of spaced apart light fixtures. During the day the lights are automatically switched off while the batteries recharge, and during nighttime, when the solar panel does not provide power, the lights are automatically switched on deriving their power from the batteries. This system still requires the running of power lines from the solar panel to the individual lighting fixtures.

A problem with this system is that when a portion of the system becomes inoperative, it is difficult for the untrained person to quickly repair the portion, often leading to removal of it, and for possible aesthetic reasons the entire emplacement of good and bad fixtures.

A self-powered marking light is disclosed in Frost et al., U.S. Pat. No. 5,065,291 fully incorporated herein by this reference, and which provides the rechargeable battery, light, photovoltaic cell and switching means in a single enclosure. This device provides that the light be emitted from a separate lens increasing the cost to manufacture the device.

It should be noted that structures near pathways should not pose a tripping hazard.

Another problem with outdoor lighting fixtures is condensation which can form on the undersurface of transparent structures which can diminish the translucent quality of the structure and can promote the growth of algae or other organic residue which can further diminish transmissivity. Condensation on exposed electronic circuits can cause shorts and can lead to rust or corrosion of metallic parts so exposed.

Therefore, there is a need for a device which minimizes or eliminates some of the above described problems with existing lighting fixtures.

### SUMMARY

The instant embodiments provide an improved interchangeable self-contained and self-powered lighting module.

Some embodiments provide for mechanisms to reduce the potential for condensation.

In some embodiments there is provided a self-contained illumination apparatus-which comprises: a first self-powered lighting module; said module comprises: an enclosure defining an internal chamber, said enclosure having a first translucent panel allowing light to pass into and out of said chamber; an electrical storage device; an electrically powered light emitter secured within said chamber in view of said panel, whereby light emitted by said emitter upon said panel can pass therethrough; a photocell secured within said chamber in view of said panel, whereby ambient light from outside of said enclosure passing through said panel illuminates said cell; and, power management circuitry adapted to recharge said storage device and deactivate said emitter in response to a threshold level of illumination.

In some embodiments said photocell is shaped and sized to have an active surface commensurate with said panel. In some embodiments-said power management circuitry utilizes the output of said photocell to detect said threshold level. In some embodiments said enclosure is substantially hermetic. In some embodiments said apparatus further comprises an amount of desiccant located within said enclosure. In some embodiments said apparatus further comprises a fixture having a receptacle shaped and dimensioned to be intimately engaged by said module.

In some embodiments said apparatus further comprises: said enclosure having a substantially quadrangular shape having a substantially planar top surface; said fixture having a substantially planar upper surface having an opening leading to said receptacle; and, wherein said receptacle and said enclosure are shaped and dimensioned such that said upper surface and said top surface are substantially coplanar when said enclosure is fully engaged in said receptacle.

In some embodiments said emitter is located to shield a portion of said photocell. In some embodiments said apparatus further comprises: a second module substantially similar in operation to said first module which comprises a second light emitter having a second color; and wherein said first emitter has a first color; and, wherein said first and second colors are different.

In some embodiments said apparatus further comprises a plurality of said modules wherein each of said plurality has a different colored light emitting device. In some embodiments said module engages and disengages said receptacle bidirectionally. In some embodiments said fixture comprises an aperture below said receptacle sized and located to allow penetration of a users finger to provide a force disengaging said module. In some embodiments said apparatus further comprises a plurality of different fixture types each having a similarly sized and shaped receptacle. In some embodiments said fixture types are selected from the group consisting of bricks, mailboxes, planters, and outdoor light housings. In some embodiments said emitter is selected from the grouping consisting of LED's, incandescent bulbs, electroluminescent films, and cold cathode ray tubes. In some embodiments said module further comprises an amount of an anti-algae agent. In some embodiments said panel has a textured undersurface having a plurality of concave pockets, and wherein said agent is located within a subset of said pockets. In some embodiments said emitter is color selectable. In some embodiments said emitter color is selected automatically according to the output of a date and time generator.

### BRIEF DESCRIPTION OF DRAWINGS

FIG. 1 is a diagrammatical partial cut-away perspective view of a self-contained illumination module for mounting in a decorative simulated brick.

FIG. 2 is a diagrammatical cross-sectional view of the module of FIG. 1 partially inserted into a receptacle in the simulated brick.

FIG. 3 is a diagrammatical cross-sectional view of the module of FIG. 1 fully inserted into the receptacle.

FIG. 4 is an exemplary circuit diagram of the self-contained illumination module.

FIG. 5 is an exemplary functional block diagram of an alternate self-contained illumination module providing selectable light emitter colors.

FIG. 6 is a diagrammatical perspective view of a number of different landscaping fixtures adapted to carry the self-contained illumination module of FIG. 1.

### DESCRIPTION OF THE EXEMPLARY EMBODIMENTS

In this specification the term photocell is used to indicate a device capable of generating electrical power when exposed to light. Such devices can include, but are not limited to solar cells, photoelectric cells and photovoltaic cells, among others. Those skilled in the art will readily appreciate the use of other devices alone or in combination with active and passive electronic circuit devices to accomplish power generation from the presence of light.

The present embodiments are described using light emitting diodes (LED's) as the electronic light emitters, however those skilled in the art will readily appreciate that other electrical light emitting devices can be used such as incandescent bulbs, electro-luminescent film such as DUREL 3 brand film commercially available from Rogers Corporation of Rogers, Conn., and cold cathode ray tubes as disclosed in Kuelbs supra.

The present embodiments disclose the use of a battery as an electrical storage device, however those skilled in the art will readily appreciate whether other devices such as capacitors or other devices can also be used.

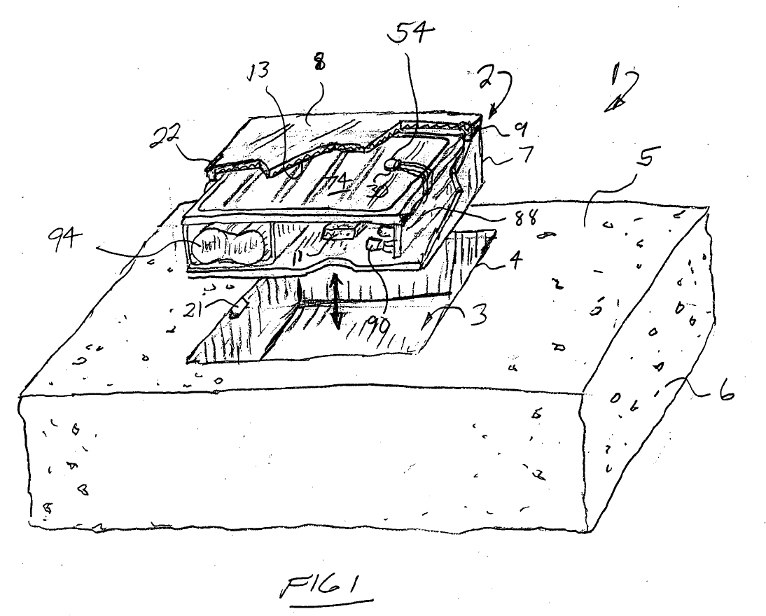

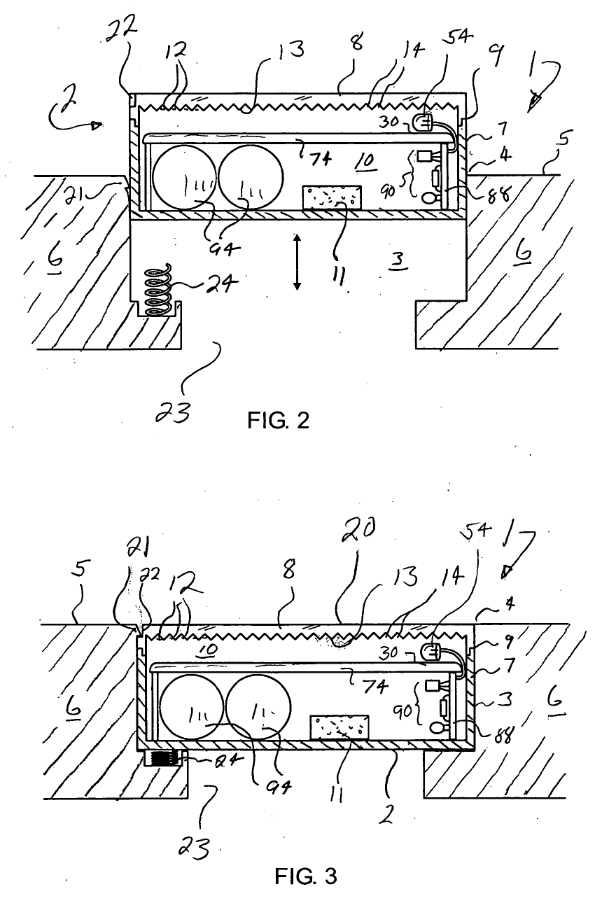

Referring now to the drawing, there is shown in FIGS. 1-3 a self-contained illumination apparatus 1 having a readily interchangeable self-powered illumination module 2 shaped and dimensioned to intimately engage a receptacle 3 extending below a top opening 4 in the top surface 5 of an outdoor fixture in the form of a simulated brick 6 made from molded plastic as disclosed in Goldman supra incorporated herein by this reference.

The module contains electronic components which provide for the self-powered illumination of the module. The primary components are a rechargeable battery pack 94, a photo cell 74 for recharging the battery pack, an LED light emitter 54, and switching circuitry 90 provided primarily on a printed circuit board (PCB) 88.

The module 2 is formed from a generally quadrangular enclosure 7 defining an inner chamber 10 and is made from a durable and substantially water and air tight material such as plastic. The enclosure has a translucent upper panel 8 made from a durable and substantially water and air tight material such as clear plastic.

The panel 8 is hermetically sealed along its periphery 9 to the enclosure 7 using a continuous layer of glue or through other hermetic sealing means such as an o-ring interposed between the panel periphery and the enclosure.

A block of desiccant material 11 is placed within the internal chamber prior to sealing to help remove moisture entering or remaining in the chamber and thereby reduce the formation of condensation.

An amount 12 of an anti-algae and/or anti-fungal agent can be deposited within the chamber. Care should be taken if the agent is applied to the undersurface 13 of the transparent panel 8 so that light transmissivity is not significantly diminished. If a transparent panel is used having texturing on its undersurface for light diffusion purposes, the agent can be applied only in concave pockets 14 to help reduce decreased transmissivity.

As shown most clearly in FIG. 3, the module 2 and the receptacle 3 are shaped and dimensioned so that when the module is fully seated within the receptacle the upper surface 20 of the module and the top surface 5 of the fixture are substantially co planar so as to help avoid being a tripping hazard when placed proximate to walkways.

The module is held in place in its fully seated position within the receptacle through means of a releaseable snap hook 21 extending inwardly from the edge of the top opening 4 of the receptacle, and engaging a corresponding ledge 22 in the outer edge of the module. The snap is disengaged using an implement such as a flat head screw driver. A lower aperture 23 is formed into the undersurface of the fixture in communication with the receptacle to allow a human operator to poke a finger from underneath to push out the module from the receptacle. Optionally, a spring 24 or other means for biasing the module 2 out of the receptacle 3 can be provided so that upon releasing of the snap 21 the module will tend to pop a distance out of the receptacle.

It is important to note that manufacturing costs can be minimized by locating both the photocell 74 and the light emitter 54 within view of a common translucent panel 8. Since the LED has a very small cross-section it can be conveniently placed over a portion 30 of the photocell and thereby disadvantageously shielding it without appreciably diminishing its output.

In order to reduce the bulkiness and cost of the module while maximizing the power gathering capability of the photocell, the panel 8 can be shaped and dimensioned to be substantially commensurate with the shape and size of the photocell.

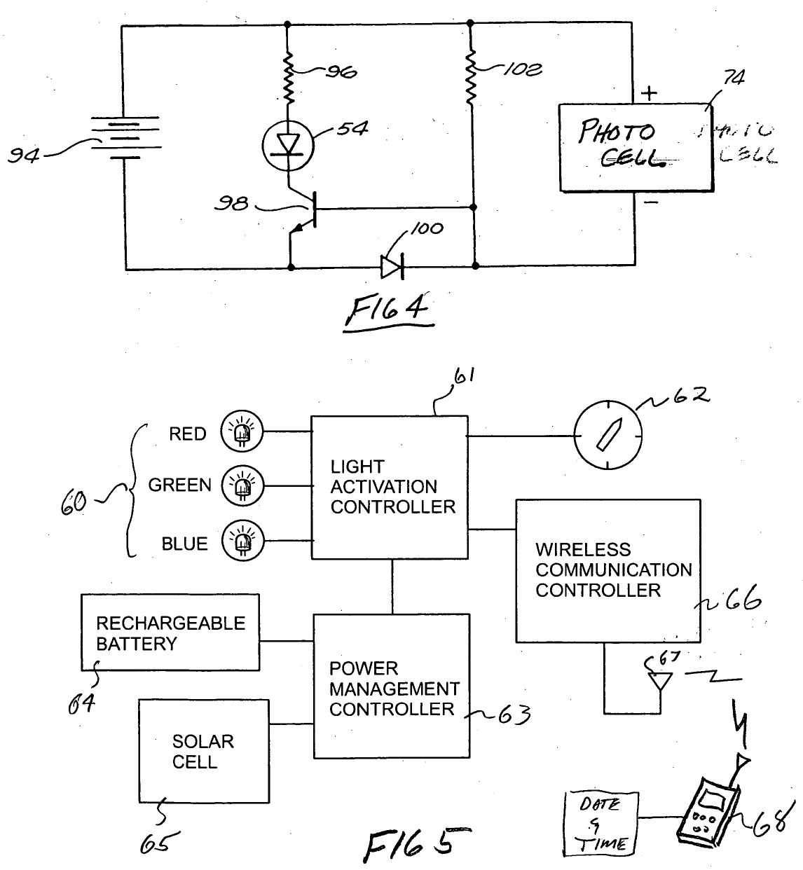

As shown in FIG. 4, the electrical interconnection of the emitter with the photocell and a battery along with the appropriate control circuit is illustrated. The photocell 74 is interconnected to a battery 94. The emitter 54 in the form of a high intensity LED is connected by a current limiting resistor 96 and a transistor 98 across the battery 94 and the photocell 74. Connected between the negative terminals of the battery 94 and the photocell 74 is a current steering diode 100. An additional resistor 102 is connected across the photocell 74. The transistor 98 is an N-P-N transistor and functions as a switch to automatically connect the battery 94 to the emitter 54 under certain predetermined conditions. The current steering diode 100 functions as a switch control means to cause the transistor 98 to conduct or not conduct thus interconnecting the emitter 54 with the battery, or alternatively, opening the circuit to prevent such from occurring. As is well known to those skilled in the art, the photocell 74, when generating electrical power as a result of some light striking the same, is used to charge the battery 94 and during such period of time, there is no need for the lighting module to emit light. Thus the emitter 54 is automatically disconnected from the power source during such time whether it be the photocell 74 or the battery 94. However, when the voltage generated by the photocell 74 drops below a predetermined threshold level as established by the level of the ambient light, then the power source consisting of the battery 94 is automatically connected so as to illuminate the emitter 54.

The current steering diode 100 functions as the control device to cause the transistor 98 to conduct or not conduct depending upon the relative levels of voltage between the photocell 74 and the battery 94. When the ambient light striking the photocell 74 is such that the output of voltage generated by it is greater than the voltage of the battery 94, the steering diode 100 will be forward biased causing current to flow from the positive terminal of the photocell through the battery 94 positive to negative, thus charging the battery 94. At the same point in time, the voltage drop across the diode 100 will be such as to reverse bias the emitter base diode of the transistor 98, thus causing it to appear as an open circuit across the battery 94 and the photocell 74. The resistor 102 has an impedance which is substantially higher than that of the battery 94 and the diode 100, thus causing little or no current flow therethrough.

When, however, the ambient light falling on the photocell falls below a predetermined level such that the output voltage from the photocell 74 is substantially less than that of the battery 94, the diode 100 becomes reverse biased and then appears as an open circuit precluding flow of current from the photocell or the battery toward the other. When such occurs, a positive voltage is applied through the resistor 102 to the base of the transistor 98. Since the emitter thereof is connected to the negative terminal of the battery, the transistor 98 is now caused to commence to conduct thereby completing the circuit through the emitter 54 across the battery 94. When such occurs, the emitter 54 will illuminate thus causing the module emit light. It will be recognized by those skilled in the art that as the ambient light increases above the predetermined level or falls below the predetermined level, the electrical power is provided to automatically charge the battery 94 or illuminate the emitter 54 respectively.

Referring now to FIG. 6, there are shown a number of landscaping fixtures of different types, namely an outdoor light fixture 40, an imitation brick 6, a mailbox 41, and a planter 42. Each type of fixture is adapted to have the same sized and shaped receptacle 43 so that a single module can be mounted in any one of a number of fixtures

It should be noted that because of the interchangeability of the modules, a number of modules can be provided having different colored light emitters as a kit. In this way, home owners change the color of the modules in response to seasonal concerns. For example, a red module, a white module and a blue module can be spaced apart each in separate fixtures to celebrate the USA independence day holiday. Similarly, the same fixtures can be interchanged with red and green modules during the Christmas holiday.

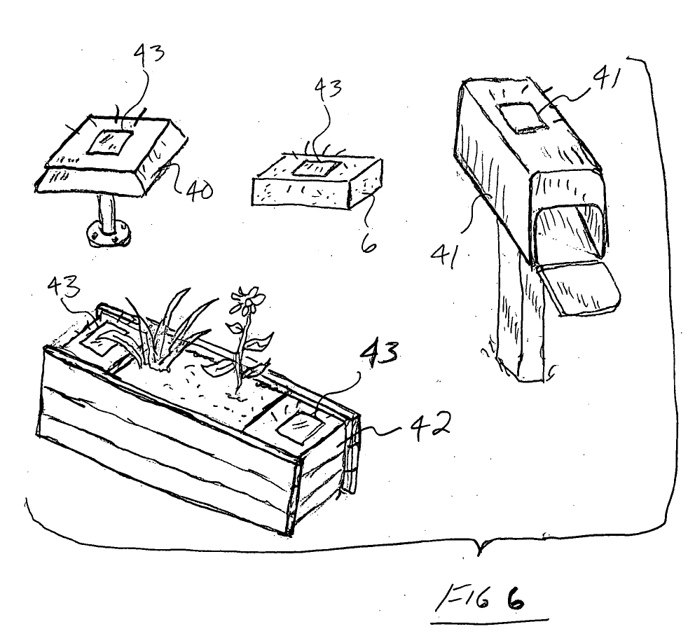

Referring back to FIG. 5, optionally, the circuitry can be modified to allow for user selectivity of the module emitter color. A bank 60 of red green and blue LEDs are selectively energized according to the output of a light activation controller 61. The light activation controller can accept color settings by way of a multi-throw switch 62 where each position of the switch determines a different combination of the LEDs to be illuminated. A power management controller 63 signals the activation controller and recharges the battery 64 in response to the output of the solar cell 65 using the same functionality described above in connection with the embodiment of FIG. 4. Optionally, the circuitry can be adapted to have a wireless communication controller 66 which receives signals through an antenna 67 from a remote controller 68 for setting the color selection. Those skilled in the electronic arts will appreciate how each of a plurality of modules can be identified by the system and receive instructions for color different from other modules. The remote controller can further comprise a date and time generator 69 and be set to automatically change the color of the group of emitters according to the status of the date and time. In this way, homeowners can conveniently configure their decorative lighting during preprogrammed holidays. Those skilled in the art will appreciate the above controllers and module circuitry can be implemented using an onboard microprocessor. Similarly the remote controller can be implemented using any number of common computer-based wireless control devices and communication protocols.

The light emitter can be in the form of an RGB LED module such as those commercially available from The LED Light, Inc. of Carson City, Nev. which allow for the selection of the color of the light displayed.

While the exemplary embodiments have been described, modifications can be made and other embodiments may be devised without departing from the spirit of the invention and the scope of the appended claims.

What is claimed is:

1. A self-contained illumination apparatus comprises:
a first self-powered lighting module;
said module comprises:
an enclosure defining an internal chamber, said enclosure having a first translucent panel allowing light to pass into and out of said chamber;
an electrical storage device;
an electrically powered light emitter secured within said chamber in view of said panel, whereby light emitted by said emitter upon said panel can pass therethrough;
a photocell secured within said chamber in view of said panel, whereby ambient light from outside of said enclosure passing through said panel illuminates said cell; and,
power management circuitry adapted to recharge said storage device and deactivate said emitter in response to a threshold level of illumination.

2. The apparatus of claim 1, wherein said photocell is shaped and sized to have an active surface commensurate with said panel.

3. The apparatus of claim 1, wherein said power management circuitry utilizes the output of said photocell to detect said threshold level.

4. The apparatus of claim 1, wherein said enclosure is substantially hermetic.

5. The apparatus of claim 1, wherein said apparatus further comprises an amount of desiccant located within said enclosure.

6. The apparatus of claim 1, wherein said apparatus further comprises a fixture having a receptacle shaped and dimensioned to be intimately engaged by said module.

7. The apparatus of claim 6, wherein said apparatus further comprises:
said enclosure having a substantially quadrangular shape having a substantially planar top surface;
said fixture having a substantially planar upper surface having an opening leading to said receptacle; and,
wherein said receptacle and said enclosure are shaped and dimensioned such that said upper surface and said top surface are substantially coplanar when said enclosure is fully engaged in said receptacle.

8. The apparatus of claim 1, wherein said emitter is located to shield a portion of said photocell.

9. The apparatus of claim 1, wherein said apparatus further comprises:
a second module substantially similar in operation to said first module which comprises a second light emitter having a second color; and
wherein said first emitter has a first color; and,
wherein said first and second colors are different.

10. The apparatus of claim 1, wherein said apparatus further comprises a plurality of said modules wherein each of said plurality has a different colored light emitting device.

11. The apparatus of claim 1, wherein said module engages and disengages said receptacle bidirectionally.

12. The apparatus of claim 1, wherein said fixture comprises an aperture below said receptacle sized and located to allow penetration of a users finger to provide a force disengaging said module.

13. The apparatus of claim 1, wherein said apparatus further comprises a plurality of different fixture types each having a similarly sized and shaped receptacle.

14. The apparatus of claim 13, wherein said fixture types are selected from the group consisting of bricks, mailboxes, planters, and outdoor light housings.

15. The apparatus of claim 1, wherein said emitter is selected from the grouping consisting of LED's, incandescent bulbs, electroluminescent films, and cold cathode ray tubes.

16. The apparatus of claim 1, wherein said module further comprises an amount of an anti-algae agent.

17. The apparatus of claim 16, wherein said panel has a textured undersurface having a plurality of concave pockets, and wherein said agent is located within a subset of said pockets.

18. The apparatus of claim 1, wherein said emitter is color selectable.

19. The apparatus of claim 18, wherein said emitter color is selected automatically according to the output of a date and time generator.
